(19) United States
(12) Patent Application Publication
(10) Pub. No.: US 2024/0291375 A1
(43) Pub. Date: Aug. 29, 2024

(54) CONTROL ARCHITECTURE AND SCHEMES TO REDUCE SWITCHING LOSSES IN DIRECT CURRENT (DC)-DC CONVERTERS

(71) Applicant: Texas Instruments Incorporated, Dallas, TX (US)

(72) Inventor: Srinivasan Iyer, Freising (DE)

(21) Appl. No.: 18/475,797

(22) Filed: Sep. 27, 2023

Related U.S. Application Data
(60) Provisional application No. 63/448,381, filed on Feb. 27, 2023.

(51) Int. Cl. H02M 1/00; H02M 3/157; H02M 3/158

(52) U.S. Cl. CPC H02M 1/0058; H02M 3/157; H02M 3/1582

(57) ABSTRACT

A controller includes a first modulator configured to generate a first control signal having an enable state at a first time, based at least in part on an output voltage of a power converter including a first half-bridge power stage and a second half-bridge power stage. The enable state of the first control signal causes a first transistor of the first half-bridge power stage to be turned on. The controller further includes a detector configured to detect a second time occurring subsequent to the first time, based on a current provided at a switching terminal of the second half-bridge power stage. The controller also includes a second modulator configured to generate a second control signal having an enable state at the second time, wherein the enable state of the second control signal causes a second transistor of the second half-bridge power stage to be turned on.

### CROSS REFERENCE TO RELATED APPLICATION

This application claims the benefit of and priority to U.S. Provisional Application No. 63/448,381 filed on Feb. 27, 2023, which is hereby incorporated by reference in its entirety.

### TECHNICAL FIELD

This description relates to power converters, and more particularly, to control architecture and schemes to reduce switching losses in direct current (DC)-DC converters.

### BACKGROUND

Power converters (such as DC-DC converters) are widely used in electronic systems such as consumer electronics, automotive systems, industrial equipment, lighting systems, etc. for converting an input voltage to an output voltage higher or lower than the input voltage. Such converters utilize one or more switching transistors (e.g., metal oxide semiconductor field effect transistor, or MOSFET) that turn on and off to regulate the output voltage. A dual channel power converter has two parallel channels for conversion of power. There are a number of non-trivial issues with providing a stable output voltage in view of the transistor switching losses.

### SUMMARY

According to an embodiment, a controller comprises a first modulator configured to generate a first control signal having an enable state at a first time, based at least in part on an output voltage of a power converter including a first half-bridge power stage and a second half-bridge power stage. The enable state of the first control signal causes a first transistor of the first half-bridge power stage to be turned on. The controller further comprises a detector configured to detect a second time occurring subsequent to the first time, based on a current provided at a switching terminal of the second half-bridge power stage. The controller also comprises a second modulator configured to generate a second control signal having an enable state at the second time, wherein the enable state of the second control signal causes a second transistor of the second half-bridge power stage to be turned on.

According to another embodiment, a controller comprises a first modulator having (i) a first modulator input to receive a power converter output voltage, (ii) a second modulator input to receive a reference voltage, and (iii) a first modulator output to provide a first pulse width modulation (PWM) signal. The controller further comprises a current comparator having (i) a current comparator input to receive a power converter switching terminal current, and (ii) a current comparator output. The controller also comprises a second modulator having (i) a third modulator input coupled to the current comparator output, (ii) a fourth modulator input coupled to the first modulator output, and (iii) a second modulator output to provide a second PWM signal.

According to yet another embodiment, a method comprises based at least in part on a feedback voltage of a DC-DC converter and a reference voltage, causing to turn on a first transistor of a first half-bridge power stage of the DC-DC converter. The method further comprises comparing a current provided at a switching terminal of a second half-bridge power stage of the DC-DC converter with a reference current; and causing to turn on a second transistor of the second half-bridge power stage, based at least in part on comparing the current.

### BRIEF DESCRIPTION OF THE DRAWINGS

FIG. 1A illustrates at least a portion of a buck/boost switching converter employing a controller for switching a plurality of switches, so as to reduce switching losses of the buck/boost switching converter, in an example.

FIG. 1B illustrates parasitic capacitances of one or more switches of the buck/boost switching converter of FIG. 1A, in an example.

FIG. 1C illustrates interconnections between an integrated circuit (IC) chip comprising the controller of the buck/boost switching converter and various other elements of the buck/boost switching converter of FIG. 1A, in an example.

FIG. 2A illustrates the controller of the converter of FIGS. 1A-1C, in an example.

FIG. 2B illustrates two PWM waveforms generated by the controller of FIG. 2A, in an example.

FIG. 3 illustrates a delay and driver circuit of the controller of FIG. 2A, in an example.

FIG. 4 illustrates a timing diagram depicting an operation of the converter of FIGS. 1A-3, in an example.

FIG. 5A illustrates at least a portion of a buck-boost switching converter employing a controller for switching a plurality of switches, so as to reduce switching losses of the buck-boost switching converter, in an example.

FIG. 5B illustrates interconnections between an IC chip comprising a controller of a buck-boost switching converter and various other elements of the buck-boost switching converter, in an example.

FIG. 6 illustrates the controller of the converter of FIGS. 5A-5B, in an example.

FIG. 7 illustrates a timing diagram depicting an operation of the converter of FIGS. 5A-6, in an example.

FIG. 8 is an example flowchart of a method of operating a switching converter, in an example.

### DETAILED DESCRIPTION

Techniques are described for implementing switching schemes in power converters. The techniques may be implemented, for example, in a power converter controller and used to reduce switching losses. In some such examples, a controller of the power converter is configured to implement a soft switching scheme, such as a zero-voltage switching (ZVS) scheme, in which the switching occurs when a voltage across a switching transistor is substantially zero. A current at a switching node or terminal of the power converter is also monitored, e.g., to determine a time of switching. Such a switching scheme reduces switching losses in the power converter, as is further described below. According to some examples, the techniques can be implemented in a dual channel power converter. Any DC-DC dual channel power converter may be used, such as a buck-boost power converter, or a buck power converter, or a boost power converter, or a buck/boost power converter. In one embodiment, the controller includes a first modulator, a detector, and a second modulator, and can be used to control a power converter that includes a first half-bridge power stage and a second half-bridge power stage. The first modulator is configured to generate a first control signal having an enable state at a first time, based at least in part on an output voltage of a power converter. The enable state of the first control signal causes a first transistor of the first half-bridge power stage to be turned on. The detector is configured to detect a second time occurring subsequent to the first time, based at least in part on a current provided at a switching terminal of the second half-bridge power stage. The second modulator is configured to generate a second control signal having an enable state at the second time. The enable state of the second control signal causes a second transistor of the second half-bridge power stage to be turned on. In some cases, the detector is configured to detect the second time, based at least in part on (i) a detection of a zero-crossing of the current provided at the switching terminal, and (ii) comparison of the feedback voltage with the reference voltage. In one such example case, the feedback voltage is a voltage across a first current terminal and a second current terminal of the first transistor, and the reference voltage is at a ground potential. Numerous other variations will be apparent based on the embodiments described herein.

### General Overview

As described above, a number of non-trivial issues are associated with providing a stable output voltage in view of the transistor switching losses in a power converter. For example, a power converter comprises one or more channels, where each channel comprises a high side switch and a low side switch. The switches may be implemented with any suitable transistor technology. The switches are switched on and off in accordance with a pulse width modulation (PWM) scheme, such that an output voltage of the converter is within or near a target voltage range. Switching losses in a transistor refer to energy losses that occur while the transistor transitions between an on state and an off state, or vice-versa. For example, when the transistor switches from the off or non-conducting state to the on or conducting state, or from the on or conducting state to the off or non-conducting state, there is a brief transition period during which the transistor voltage and current are simultaneously changing. This results in power dissipation and energy losses in the transistor.

Accordingly, techniques are described for implementing switching schemes that reduce switching losses in a DC-DC power converter comprising two (or more) channels, where each channel includes a high side switch and a low side switch. In some such examples, a controller of the power converter is configured to implement a soft switching scheme, such as a zero-voltage switching (ZVS) scheme, in which the switching occurs when a voltage across a switching transistor is substantially zero and/or a current at the switching terminal is substantially zero. For example, a current at a switching terminal of the converter is monitored by the controller, e.g., to determine a time of switching. When a zero value of the current (or a non-zero reference value of the current) is detected, the switching of transistors of a channel of the power converter is caused by the controller. Similarly, a voltage across a switching transistor of the converter is monitored by the controller, e.g., to determine a time of switching. When a reference value (e.g., zero volts) of the voltage is detected, the switching of transistors of a channel of the power converter is caused by the controller. In some example cases, the switching of transistors of the power converter is based on a combination of such current and voltage detections. Such switching schemes can be used to reduce switching losses in the power converter. Numerous other variations will be apparent based on the embodiments described herein.

### Electronic System-Buck/Boost Converter

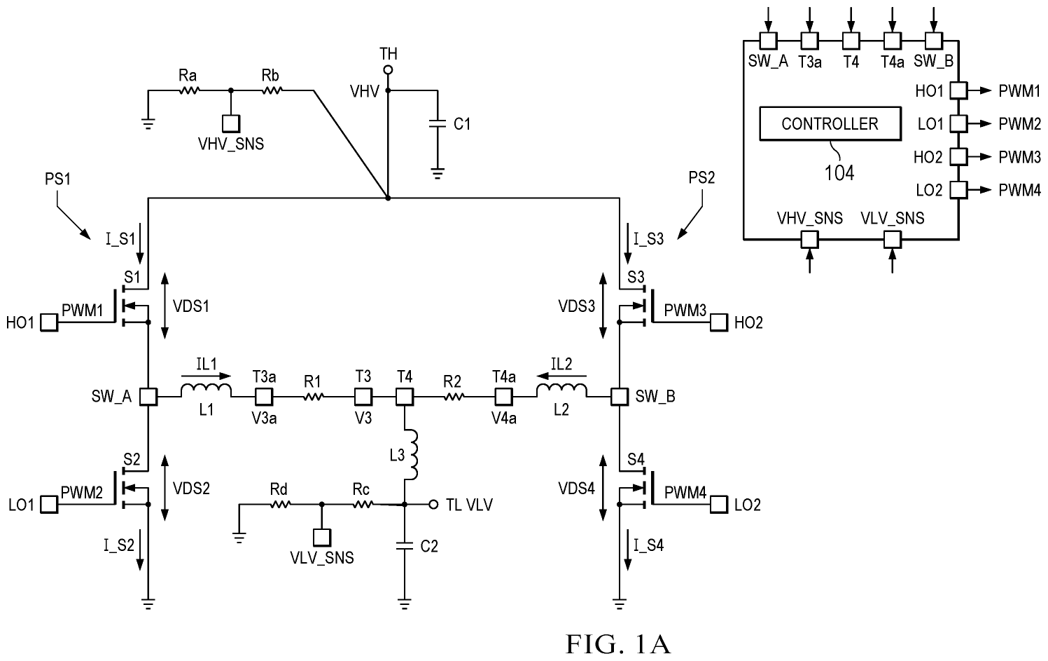

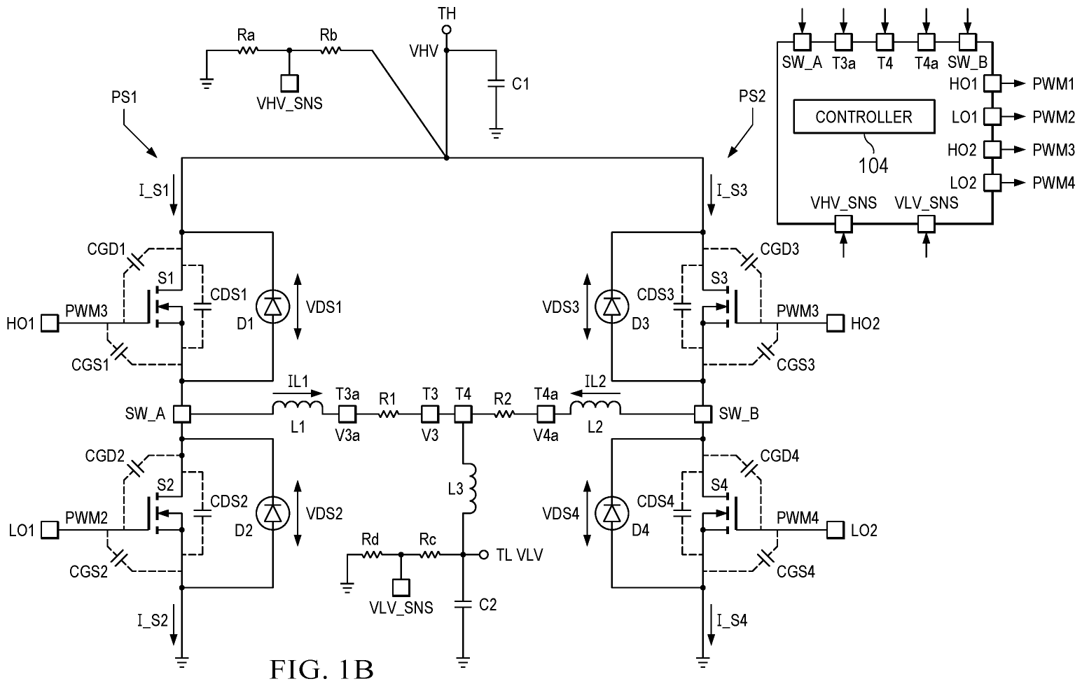

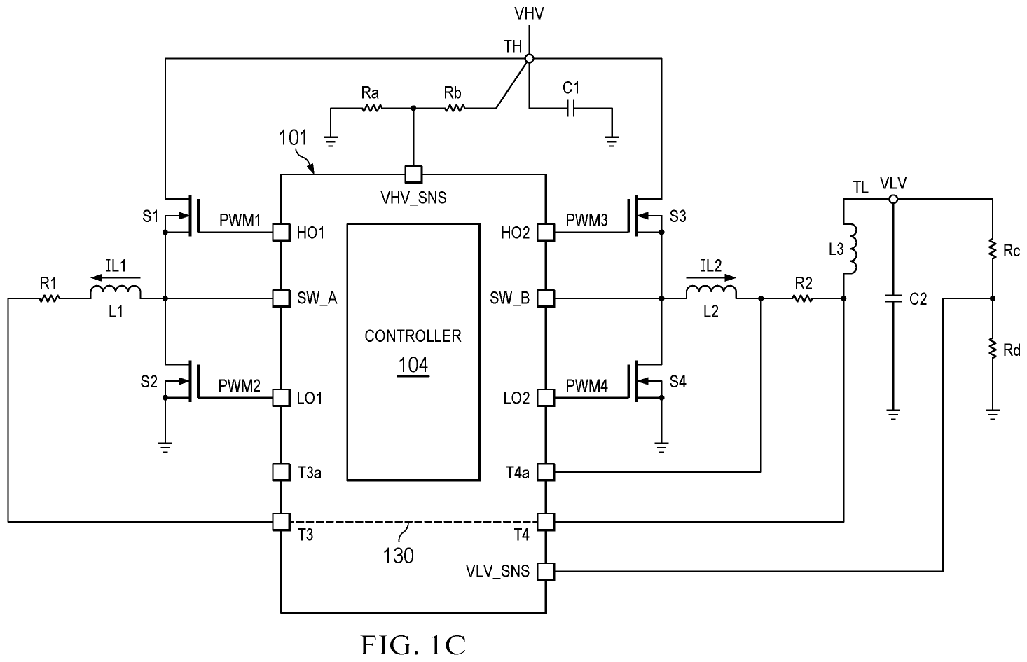

FIG. 1A illustrates at least a portion of a buck/boost switching converter 100 (also referred to herein as a buck/boost converter 100, or simply as a converter 100) employing a controller 104 for switching a plurality of switches S1, . . . , S4, so as to reduce switching losses of the buck/boost switching converter 100, in an example. FIG. 1B illustrates parasitic capacitances of one or more switches of the buck/boost switching converter 100 of FIG. 1A. FIG. 1C illustrates interconnections between an integrated circuit (IC) chip 101 comprising the controller 104 of the buck/boost switching converter 100 and various other elements of the buck/boost switching converter 100.

Referring to FIGS. 1A-1C, the converter 100 comprises a high voltage terminal TH and a low voltage terminal TL. In a buck mode of operation of the converter 100, the high voltage terminal TH operates as an input terminal of the converter 100 and is provided with an input high voltage VHV, and the low voltage terminal TL operates as an output terminal of the converter 100 and generates an output low voltage VLV, where the high voltage VHV is greater than the low voltage VLV.

On the other hand, in a boost mode of operation of the converter 100, the low voltage terminal TL operates as an input terminal of the converter 100 and is provided with the input low voltage VLV, and the high voltage terminal TH operates as an output terminal of the converter 100 and generates the output high voltage VHV. Thus, the converter 100 is a bidirectional converter that can operate in both the buck mode and the boost mode of operation. The terminal TH is at a higher voltage than the terminal TL during both the buck mode and the boost mode of operation. The converter 100 is also referred to herein as a buck/boost converter, as it can operate at the buck mode and the boost mode of operation.

In the example of FIGS. 1A-1C, the converter 100 is a dual channel converter, e.g., comprises two half-bridge power stages PS1 and PS2 (the power stages are labelled in FIGS. 1A and 1B). Each of the power stages PS1 and PS2 comprises a corresponding high side switch and a corresponding low side switch. For example, power stage PS1 comprises a high side switch S1 coupled between the high voltage terminal TH and a switching terminal SW_A, and a low side switch S2 coupled between the switching terminal SW_A and a ground terminal. Similarly, power stage PS2 comprises a high side switch S2 coupled between the high voltage terminal TH and another switching terminal SW_B, and a low side switch S4 coupled between the switching terminal SW_B and the ground terminal. In an example, the switches S1, . . . , S4 may be transistors, such as n-channel FETs, although other suitable switching elements may also be used.

A control terminal (such as a gate terminal) of the switch S1 is coupled to a control terminal HO1 of the chip 101, which provides a PWM1 control signal to the control terminal of the switch S1. A control terminal (such as a gate terminal) of the switch S2 is coupled to a control terminal LO1 of the chip 101, which provides a PWM2 control signal to the control terminal of the switch S2.

In an example, a high value or enable state of PWM1 and PWM2 signals respectively enable or turn on the switches S1 and S2, although a different control scheme may also be possible. Similarly, a low value or disable state of PWM2 and PWM2 signals respectively disable or turn off the switches S1 and S2.

A control terminal (such as a gate terminal) of the switch S3 is coupled to a control terminal HO2 of the chip 101, which provides a PWM3 control signal to the control terminal of the switch S3. A control terminal (such as a gate terminal) of the switch S4 is coupled to a control terminal LO2 of the chip 101, which provides a PWM4 control signal to the control terminal of the switch S4.

In an example, a high value or enable state of PWM3 and PWM4 signals respectively enable or turn on the switches S3 and S4, although a different control scheme may also be possible. Similarly, a low value or disable state of PWM3 and PWM4 signals respectively disable or turn off the switches S3 and S4.

When the switch S1 is enabled, the switch S1 provides the high voltage VHV to the switching terminal SW_A. Similarly, when the switch S2 is enabled, the switch S3 provides the high voltage VHV to the switching terminal SW_B. On the other hand, when the switch S2 is enabled, the switch S2 couples the ground terminal to the switching terminal SW_A. Similarly, when the switch S4 is enabled, the switch S4 couples the ground terminal to the switching terminal SW_B.

The operation of the switches S1 and S2 are complementary in nature, e.g., such that at a given time, only one of the switches S1 and S2 is on (e.g., when switch S1 is on, switch S2 is off, and vice versa). Similarly, the operation of the switches S3 and S4 are complementary in nature, e.g., such that at a given time, only one of the switches S3 and S4 is on (e.g., when switch S3 is on, switch S4 is off, and vice versa). This avoids shorting between the terminal TH and the ground terminal through the switches S1 and S2, or though the switches S3 and S4.

The chip 101 comprises a plurality of terminals T4, T3a, T3, and T4a, as illustrated in FIGS. 1A-1C. For example, an inductor L1 is coupled between the switching terminal SW_A and the terminal T3a, a resistor R1 is coupled between the terminal T3a and the terminal T3, a resistor R2 is coupled between the terminal T4 and the terminal T4a, and an inductor L2 is coupled between the terminal T4a and the switching terminal SW_B. Furthermore, an inductor L3 is coupled between the terminal T4 and the low voltage terminal TL. Note that in FIG. 1C, the switches S1, . . . , S4 are illustrated to be external to the chip 101. However, in another example, the switches S1, . . . , S4 may be internal to the chip 101 (e.g., depending on a power rating of the switches S1, . . . , S4).

As illustrated in FIGS. 1A-1C, the terminals T3 and T4 are electrically coupled, such as shorted. This is symbolically illustrated as dotted line 130 in FIG. 1C. For example, the electrical coupling between the terminals T3 and T4 may be through the chip 101, or external to the chip 101. In an example, the two terminals T3 and T4 may be replaced by a common terminal on the chip 101.

Thus, each of the terminals T3a, T3, T4, and T4a is coupled to a corresponding inductor. Accordingly, the terminals T3a, T3, T4, and T4a may also be referred to herein as inductor terminals. Also, the terminals T3 and T4 (which can be replaced by a single common terminal) are coupled to each of the switching terminals SW_A and SW_B (e.g., through respective inductors and resistors), and hence, the terminals T3 and T4 are also referred to herein as a common switching terminal, or simply as a switching terminal, in an example.

The high voltage terminal TH is coupled to the ground through a resistive voltage divider comprising resistors Ra and Rb. For example, the resistors Ra and Rb are coupled in series between the high voltage terminal TH and the ground terminal. The resistor Rb also is coupled between the high voltage terminal TH and a voltage sensing terminal VHV_SNS on the chip 101, and the resistor Ra is coupled between the ground terminal and the voltage sensing terminal VHV_SNS on the chip. The voltage sensing terminal VHV_SNS is on the chip 101. The chip 101 senses the voltage at the voltage sensing terminal VHV_SNS, to estimate a voltage VHV at the high voltage terminal TH. The high voltage terminal TH is also coupled to the ground through a capacitor C1.

The low voltage terminal TL is coupled to the ground through another resistive voltage divider comprising resistors Rc and Rd. For example, the resistors Rc and Rd are coupled in series between the low voltage terminal TL and the ground terminal. The resistor Rc is coupled between the low voltage terminal TL and a voltage sensing terminal VLV_SNS on the chip 101, and the resistor Rd is coupled between the ground terminal and the voltage sensing terminal VLV_SNS. The voltage sensing terminal VLV_SNS is on the chip 101. The chip 101 senses the voltage at the voltage sensing terminal VLV_SNS, to estimate a voltage VLV at the low voltage terminal TL. The low voltage terminal TL is also coupled to the ground through a capacitor C2.

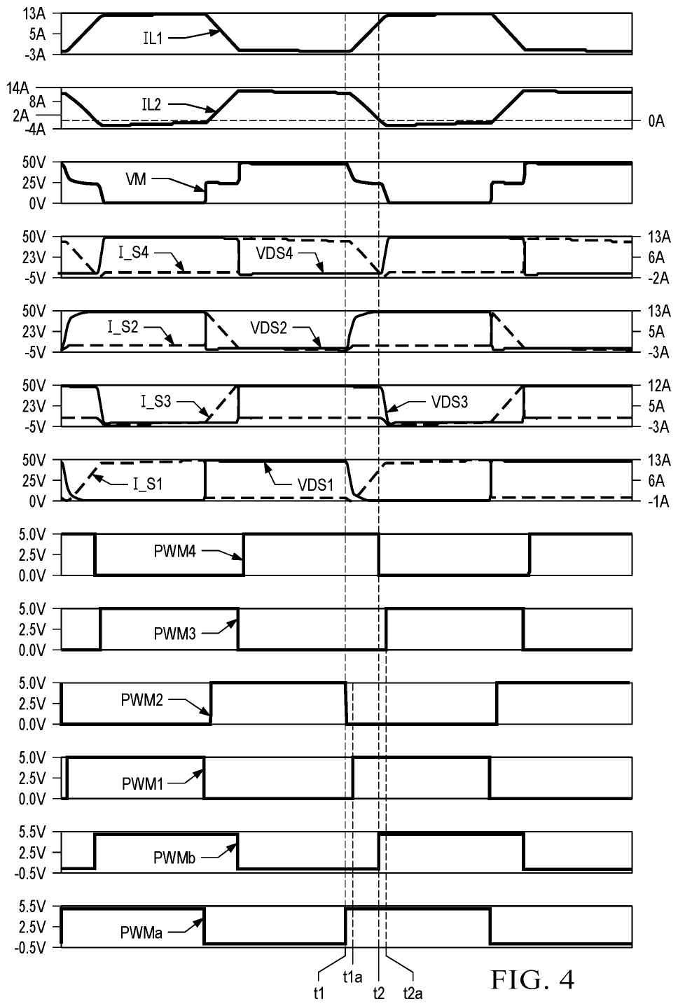

FIG. 1B illustrates various parasitic capacitances CDS1, CDS2, CDS3, and CDS4 formed respectively at the switches S1, S2, S3, and S4 (e.g., between two current terminals, such as between drain and source terminals, of these switches), in an example. Also illustrated are parasitic capacitances CGD1, CGD2, CGD3, and CGD4 formed respectively at the switches S1, S2, S3, and S4 (e.g., between a current terminal, such as the drain terminal, and a control terminal of these switches), in an example. Also illustrated, in an example, are parasitic capacitances CGS1, CGS2, CGS3, and CGS4 formed respectively at the switches S1, S2, S3, and S4 (e.g., between another current terminal, such as the source terminal, and a control terminal of these switches). In an example, the inductors L1 and L2 are selected in way to reverse charge across Coss (e.g., output capacitance, not shown) of both half bridge stages, e.g., by making inductor currents IL1 and IL2 go negative with a trapezoidal nature (the trapezoidal current waveforms of the inductor currents IL1 and IL2 are illustrated in FIG. 4 below).

In one embodiment, the inductors L1 and L2 have relatively low inductance values (e.g., owing to low values of the output capacitances Coss of the total bridge). For example, each of the inductors L1 and L2 have inductance values low enough such that one or both these inductors can be formed as trace inductors on a circuit board (such as a printed circuit board or PCB), and/or as trace inductors within a chip. In an example, the inductances of each of the inductors L1 and L2 is in the range of 10-1500 nano Henry, or in a subrange thereof, such as about 300 to 600 nano Henry. In an example, the inductances of each of the inductors L1 and L2 is based on a frequency of operation of the converter 100. A higher frequency of the converter 100 necessitates a relatively lower value of the inductances, and vice versa.

In contrast, in an example, the inductance of the inductor L3 is higher than the inductances of the inductors L1 and L2. For example, the inductor L3 can be in the range of 1 to 100 micro Henry. In an example, the inductance of the inductor L3 is higher than the inductances of the inductors L1 and L2 by at least two times, or least 5 times, or at least 10 times, or at least 20 times, or at least 50 times, or at least 100 times.

As illustrated in FIG. 1A, a current through the inductor L1 is referred to as current IL1, and a current through the inductor L2 is referred to as current IL2. For example, the chip 101 has terminals T3 and T3a for sensing voltages at these two terminals. In an example, the chip 101 measures the voltage across terminals T3 and T3a, and knows the value of the resistor R1. Thus, by measuring the voltage drop across resistor R1, the chip 101 (e.g., the controller 104) estimates the current IL1 through the resistor R1 and also through the inductor L1.

Similarly, the chip 101 has terminals T4 and T4a for sensing voltages at these two terminals. In an example, the chip 101 measures the voltage across terminals T4 and T4a, and knows the value of the resistor R2. Thus, by measuring the voltage drop across resistor R2, the chip 101 (e.g., the controller 104) estimates the current IL2 through the resistor R2 and also through the inductor L2.

A voltage across two current terminals of the switch S1 (e.g., across source and drain terminals of the switch S1) is referred to as VDS1. Similarly, voltages across two corresponding current terminals of the switches S2, S3, and S4 (e.g., across source and drain terminals of the corresponding switches) are respectively referred to as VDS2, VDS3, and VDS4, as labelled in FIG. 1A.

For example, the chip 101 (such as the controller 104) estimates the voltage VHV at terminal TH (e.g., using the voltage divider comprising the resistors Ra and Rb, as described above). The chip 101 also senses the voltage at the switching terminal SW_A (e.g., the terminal SW_A is on the chip 101). Accordingly, the chip 101 estimates the voltage VDS1, by estimating the voltage difference between the terminals TH and SW_A. The chip 101 similarly estimates the voltages VDS2, VDS3, and VDS4. A voltage across the high voltage terminal TH and the inductor terminal T4 is referred to as VM, which can also be similarly estimated. Currents through the switches S1, S2, S3, and S4 are respectively referred to as currents IS1, IS2, IS3, IS4.

The controller 104 within the chip 101 controls a switching operation of the converter 100. For example, the controller 104 outputs the PWM1, . . . , PWM4 control signals to control switching of the switches S1, . . . , S4, thereby controlling switching operations of the converter 100.

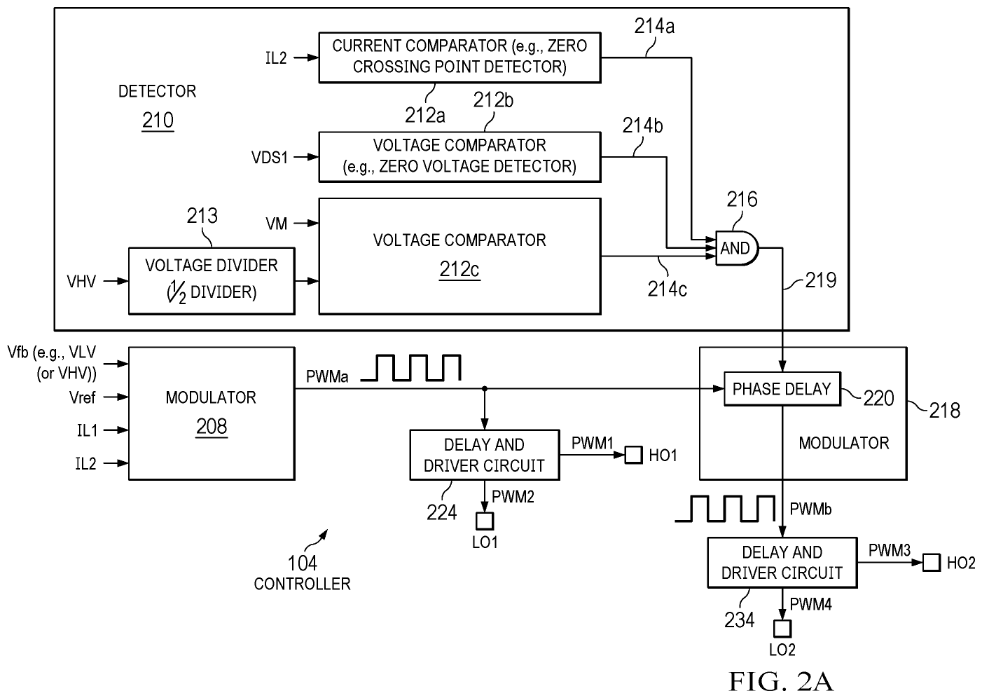

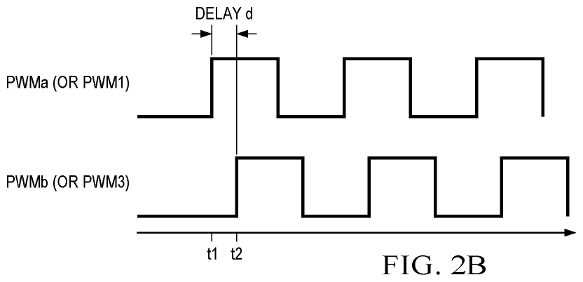

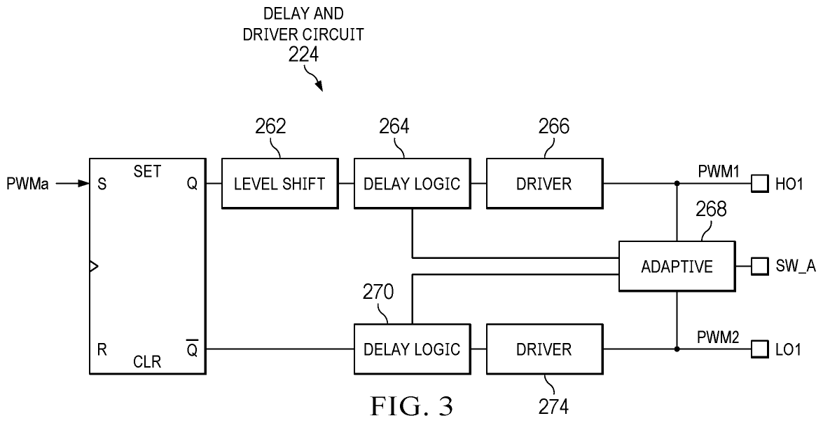

FIG. 2A illustrates the controller 104 of the converter 100 of FIGS. 1A-1C, in an example. FIG. 2B illustrates two PWM waveforms PWMa and PWMb generated by the controller 104 of FIG. 2A, in an example. FIG. 3 illustrates an example implementation of the delay and driver circuit 224 of the controller 104 of FIG. 2A, in an example. FIG. 4 illustrates a timing diagram depicting an operation of the converter 100 of FIGS, in an example. 1A-3. FIGS. 2A, 2B, 3, and 4 are described in unison.

Referring to FIG. 2A, the controller 104 comprises a modulator 208 that has a first input receiving a feedback voltage Vfb, and a second input receiving a reference voltage Vref. The feedback voltage Vfb is indicative of an output of the converter 100. For example, in the buck mode, the high voltage terminal TH operates as an input terminal of the converter 100 and is provided with the input high voltage VHV, and the low voltage terminal TL operates as an output terminal of the converter 100 and generates the output low voltage VLV. Accordingly, in the buck mode of operation, the feedback voltage Vfb is the low voltage VLV at the output terminal TL of the converter 100. Note that the modulator 208, instead of receiving the voltage VLV, receives an output of the resistive voltage divider comprising the resistors Rc and Rd as the feedback voltage Vfb (e.g., through terminal VLV_SNS), where the feedback voltage Vfb is indicative of the output voltage VLV of the converter 100.

Similarly, in the boost mode, the low voltage terminal TL operates as an input terminal of the converter 100 and is provided with the input low voltage VLV, and the high voltage terminal TH operates as an output terminal of the converter 100 and generates the output high voltage VHV. Accordingly, in the boost mode of operation, the feedback voltage Vfb is the voltage VHV at the output terminal TH of the converter 100. Note that the modulator 208, instead of receiving the voltage VHV, receives an output of the resistive voltage divider comprising the resistors Ra and Rb as the feedback voltage Vfb (e.g., through terminal VHV_SNS), where the feedback voltage Vfb is indicative of the output voltage VHV of the converter 100.

The reference voltage Vref is a target output of the converter 100. In one embodiment, the modulator 208 includes a comparator (e.g., an error amplifier) to compare the voltage Vfb (which is indicative of an output voltage of the converter 100) with the reference voltage Vref (which is a target output of the converter 100). In an example, the modulator 208 also receives the inductor currents IL1 and IL2. In an example, an appropriate control scheme may then be employed to generate a pulse width modulated signal PWMa. In an example, an average current mode control may be employed, in which an average (e.g., average over time) of a summation of the inductor currents IL1 and IL2 may be used, in conjunction with Vref and Vfb, to generate the PWMa signal. In another example, another appropriate control scheme may also be employed, such as a peak current mode control, a valley current mode control, or a hysteresis control mode.

The PWMa signal is used to generate control signals PWM1 and PWM2, which are respectively received by the control terminals of the switches S1 and S2. Thus, the PWMa signal effectively controls the two switches S1 and S2 of the power stage PS1.

In one embodiment, a delay and driver circuit 224 receives the PWMa signal, and generates the control signals PWM1 and PWM2. In an example, the delay and driver circuit 224 generates the control signals PWM1 and PWM2, such that the control signals PWM1 and PWM2 are at least in part complimentary in nature. For example, both the control signals PWM1 and PWM2 may not be at a high or enable state simultaneously, such that both switches S1 and S2 are not switched on simultaneously (e.g., because if both switches S1 and S2 are switched on simultaneously, this would effectively short the high voltage terminal TL to the ground terminal through the switches S1 and S2).

Additionally, the delay and driver circuit 224 introduces a dead time delay between disabling of PWM2 and enabling of PWM1, such that there is a delay between switching off of the switch S2 and switching on of the switch S1 (see delay between time t1 and time t1a in FIG. 4 herein below). The dead time delay provides a safety margin, such that the switches S1 and S2 are not switched on simultaneously. In an example, the delay may be adaptive in nature, and may be updated in real or near real time.

FIG. 3 illustrates a delay and driver circuit 224 of the controller 104 of FIG. 2A, in an example. For example, the PWMa signal is received by a flip flop 260, such as an SR flip flop 260, having complementary outputs. A first signal output by the Q terminal of the flip flop 260 is received by a level shifter 262, which level shifts a voltage level of the voltage (e.g., based on a voltage rating of the control terminal of the switch S1), which may be used to drive the switch S1. Both the first signal output by the Q terminal of the flip flop and a second signal output by the Q̅ terminal of the flip flop 260 are delayed respectively by delay logic 264 and 270, e.g., to provide the dead time delay described above (e.g., delay between time t1 and t1a of FIG. 4). In an example, the delay may be adaptively controlled by an adaptive delay circuit 268, which receives feedback from terminals HO1, LO1, and SW_A, and controls the delay provided by the delay logics 264 and 270. A driver circuit 266 generates the PWM1 at the HO1 terminal, and a driver circuit 274 generates the PWM2 at the LO1 terminal. Although FIG. 3 illustrates one example implementation of the delay and driver circuit 224, the delay and driver circuit 224 may have any other appropriate structure.

FIG. 4 illustrates the PWMa signal, and also illustrates the PWM1 and PWM2 signals derived from the PWMa signal by the delay and driver circuit 224, in an example. As illustrated in FIG. 4, PWM2 is substantially an inverter waveform of PWMa (e.g., when PWMa is high, PWM2 is low, and vice versa). The inversion may be achieved by the flip flop 260 of FIG. 3.

The transition from low to high of the PWM1 signal is delayed with respect to that of the PWMa signal, such as delayed by the dead time delay described above, e.g., the delay between time t1 when PWMa transitions from low to high and time t1a when PWM1 transitions from low to high. The dead time delay provides a safety margin, such that the switches S1 and S2 are never switched on simultaneously.

Referring again to FIG. 2A, the controller 104 further includes another modulator 218 that has a first input coupled to an output of the modulator 208, where the modulator 218 receives the PWMa signal from the modulator 208 via the first input. The modulator 218 also has a second input coupled to an output of a detector 210, where the modulator 218 receives an enable signal 219 from the detector 210 via the second input. In an example, based on the PWMa signal and the enable signal 219, the modulator 218 generates another PWMb signal, which is a pulse width modulated signal. In an example and as described below, the PWMb signal is a time-delayed or phase shifted version of the PWMa signal. Generation of the PWMb signal at the modulator 218 is described below.

In one embodiment, the PWMb signal is received by a delay and driver circuit 234, which generates PWM3 and PWM4 signals at terminals HO2 and LO2, respectively. The delay and driver circuit 234 may be at least in part similar to the delay and driver circuit 224 described above. For example, the delay and driver circuit 234 receives the PWMb signal, and generates the control signals PWM3 and PWM4, such that the control signals PWM3 and PWM4 are at least in part complimentary in nature. For example, both the control signals PWM3 and PWM4 may not be at a high or enable state simultaneously, such that both switches S3 and S4 are not switched on simultaneously (e.g., because if both switches S3 and S4 are switched on simultaneously, this would effectively short the high voltage terminal TH to the ground terminal through the switches S3 and S4).

Additionally, the delay and driver circuit 234 introduces a dead time delay between disabling of PWM4 and enabling of PWM3, such that there is a delay between switching off of the switch S4 and switching on of the switch S3 (see delay between time t2 and time t2a in FIG. 4 herein below). The dead time delay provides a safety margin, such that the switches S3 and S4 are not switched on simultaneously. In an example, the structure of the delay and driver circuit 234 may be at least in part similar to the structure of the delay and driver circuit 224 described above with respect to FIG. 3.

Referring again to FIG. 2A, the detector 210 asserts the enable signal 219, e.g., to delay the PWMb signal with respect to the PWMa signal. For example, referring to FIG. 4, the PWMa signal transitions to logic high state at time t1, based on which the PWM1 transitions to the logic high state at time t1a (note the dead time delay between times t1 and t1a, described above). However, the modulator 218 generates the PWMb signal, such that PWMb signal transitions to logic high state at time t2. Thus, there is a delay of the PWMb signal with respect to PWMa signal, which is also illustrated in FIG. 2B. Once the PWMb transitions to high at time t2, PWM3 transitions to high at time t2a (note the dead time delay between times t2 and t2a, described above).

Thus, the modulator 218 delays transition to high of the PWMb with respect to that of the PWMa signal. For example, the detector 210 monitors one or more parameters of the converter 100, and controls this delay through assertion of the enable signal 219. For example, referring to FIGS. 2A and 4, PWMb transitions to the high state at time t2, subsequent to PWMa transitioning to high state at time t1, when one or more of the following conditions are satisfied:

(i) current IL2 has a zero crossover (e.g., as monitored by a current comparator 212a of the detector 210), Condition 1

(ii) voltage VDS1 is substantially zero (e.g., as monitored by a voltage comparator 212b of the detector 210), and/or Condition 2

(iii) the voltage VM (see FIG. 1A) is about half of the voltage VHV at the high voltage terminal TH (e.g., as monitored by a voltage comparator 212c of the detector 210). Condition 3

For example, the detector 210 detects satisfaction of one or more of the conditions 1, 2, and 3, and asserts the enable signal 219 when one or more of the conditions 1, 2, and 3 are satisfied. For example, the detector 210 detects a time t2 when one or more of the conditions 1, 2, and 3 are satisfied, and asserts the enable signal at time t2. Based on the enable signal 219 being asserted at time t2, the modulator 218 transitions the PWMb signal at the high logic state at time t2, as illustrated in FIG. 4.

In one embodiment, the detector 210 checks for satisfaction of the condition 1, and at least one of the conditions 2 and 3 above. In one example, the detector 210 checks for satisfaction of the conditions 1 and 2, to assert the enable signal 219. In another example, the detector 210 checks for satisfaction of the conditions 1 and 3, to assert the enable signal 219. In yet another example, the detector 210 checks for satisfaction of the conditions 1, 2, and 3, to assert the enable signal 219. Any other combination of the conditions 1, 2, and 3 may also be possible.

As illustrated in FIG. 4, due to the tuning of the inductors L1 and L2, each of the currents IL1 and IL2 has a roughly trapezoidal shape. Also, when inductor current IL2 crosses zero at t2, the current I_S3 through the switch S2 is also zero or close to zero, as illustrated in FIG. 4. Accordingly, the switching of the switches S3 and S4 occur (e.g., switch S4 is switched off at time t2, and switch S3 is switched on at time t2a) when the currents I_S3 and I_S4 through the switches S3 and S4, respectively, are substantially zero. This eliminates or at least reduces power loss at switches S3 and S4 during switching of these switches, because of the substantially zero current through the switches S3 and S4 during the switching. Thus, the modulator 218 delays transition of the PWMb signal to time t2, resulting in soft switching of the switches S3 and S4, and zero or reduced switching losses of these switches.

In an example, to ensure that the zero crossing of the current IL2 is accurately detected during various loading conditions, in an example, one or more other conditions, such as conditions 2 and 3, may also be checked. For example, at time t2, the voltage VDS1 is also substantially zero (e.g., resulting in a zero voltage switching), and the voltage VM is roughly equal to half of the voltage VHV at the high voltage terminal TH.

The detector 210 comprises a current comparator 212a having an input to receive the current IL2 flowing through the inductor L2. Note that the current IL2 is detected by the chip 101, e.g., by measuring voltage drop across terminals T4 and T4a of the resistor R2, as described above.

In an example, the current comparator 212a is a zero crossing point detector, such as detects when the current IL2 crosses substantially zero value. Thus, the current comparator 212a checks for the above described condition 1. In effect, the current comparator 212a compares the current IL2 with a zero reference current. For example, the current IL2 is zero at time t2. The current comparator 212a transitions a signal 214a to an enable state, in response to detecting the zero crossing of the current IL2. In an example, the current comparator 212a is employed with hysteresis.

The detector 210 further comprises a voltage comparator 212b having an input to receive the voltage VDS1 across the current terminals of the switch S1. In an example, the voltage detector 212b is a zero voltage detector, such as detects when the voltage VDS1 has a substantially zero value. Thus, the voltage detector 212b compares the voltage VDS1 with a zero reference voltage. For example, referring to FIG. 4, the voltage VDS1 is zero at time t2. Thus, the voltage comparator 212b checks for the above described condition 2. The voltage comparator 212b transitions a signal 214b to an enable state, in response to detecting the zero value of VDS1. In an example, the voltage comparator 212b is employed with hysteresis.

The detector 210 further comprises a voltage comparator 212c having a first input to receive a representation of the voltage difference VM across the terminals TH and T4 (or a voltage at terminal T4), and a second input to receive a representation of half of the voltage VHV. For example, a voltage divider 213 receives a representation of the voltage VHV, and generates a voltage that is representative of half the voltage VHV. In an example, the voltage divider comprising the resistors Ra and Rb can be used for the voltage divider 213. The voltage comparator 212c compares the voltages VM and half of voltage VHV, e.g., checks for satisfaction of the condition 3 described above. For example, referring to FIG. 4, this condition is also satisfied at time t2. The voltage comparator 212c transitions a signal 214c to an enable state, in response to satisfaction of this condition. In an example, the voltage comparator 212c is employed with hysteresis.

As described above, one or more of the conditions 1, 2, and 3 are to be satisfied, and hence, the detector 210 may correspondingly include one or more of the comparators 212a, 212b, and 212c. For example, if conditions 1 and 2 are to be checked, then comparators 212a and 212b may be present within the detector 210, and comparator 212c may be optionally absent. In another example, if conditions 1 and 3 are to be checked, then comparators 212a and 212c may be present within the detector 210, and comparator 212b may be optionally absent.

An AND logic gate 216 receives one or more of the signals 214a, 214b, 214c (e.g., depending on which of the comparators 212a, 212b, 212c are present within the detector 210). The AND gate 216 outputs a signal 219, which is at an enable state when all inputs to the AND gate 216 are at the enable state (e.g., when the required one or more of the conditions 1, 2, and 3 are satisfied).

Thus, the detector 210 detects the time t2 when the conditions 1, 2, and/or 3 are satisfied. Upon satisfaction of the condition(s), the enable signal 219 has an enable stage (e.g., is asserted), based on which the modulator 218 transitions the PWMb signal to the enable or high state, as described above. For example, the modulator 218 comprises a phase delay logic 220, which delays the phase of the PWMa signal to generate the PWMb signal, where the delay is estimated based on when the enable signal 219 transitions to the enable state or is asserted. In an example, the delay between times t1 and time t2 may be based on an operating temperature of the converter 100, a load of the converter 100, a supply voltage (e.g., VHV or VLV), and parasitic capacitances CDS1, . . . , CDS4.

### Buck-Boost Converter

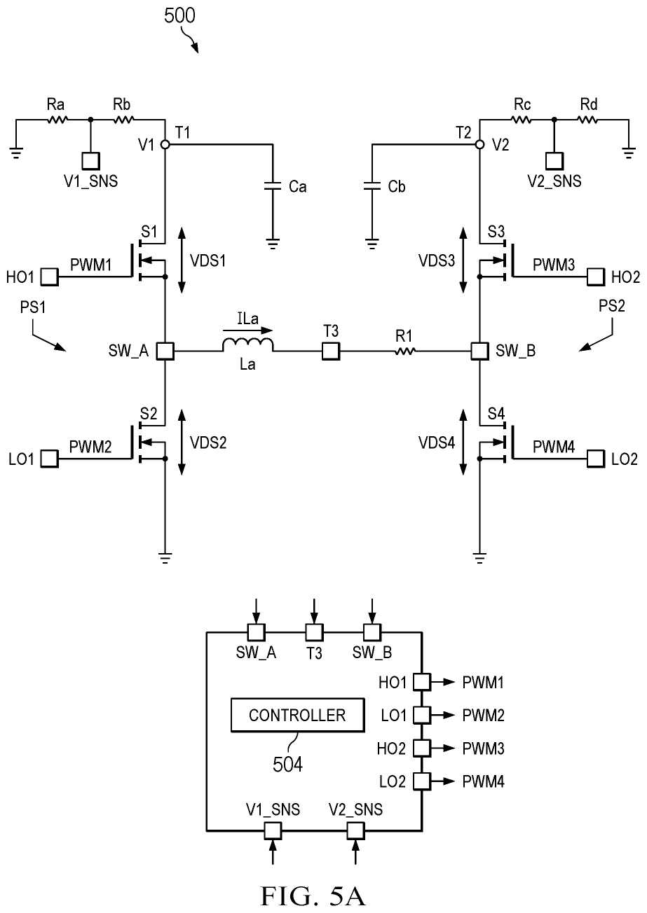

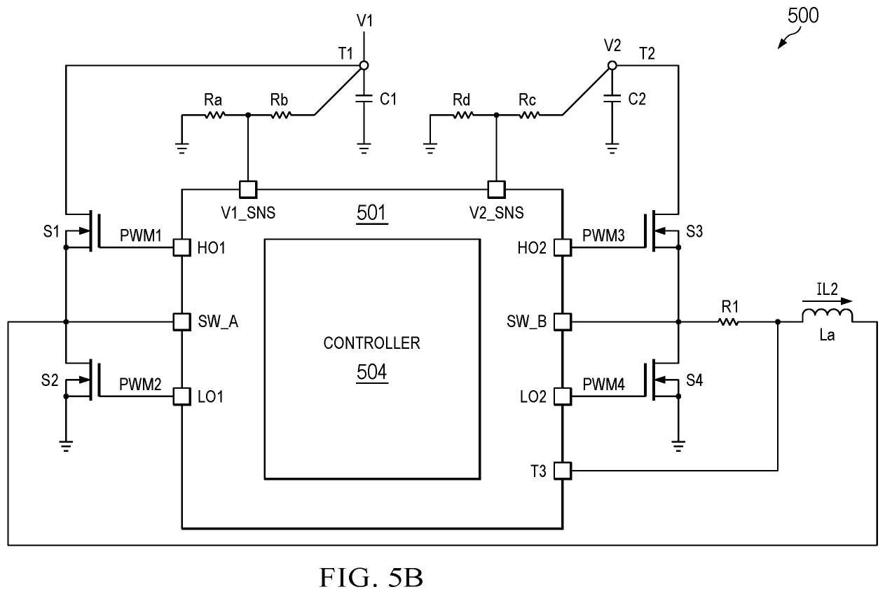

FIG. 5A illustrates at least a portion of a buck-boost switching converter 500 (also referred to herein as a buck-boost converter 500, or simply as a converter 500) employing a controller 504 for switching a plurality of switches S1, . . . , S4, so as to reduce switching losses of the buck-boost switching converter 500, in an example. FIG. 5B illustrates interconnections between an integrated circuit (IC) chip 501 comprising the controller 504 of the buck-boost switching converter 500 and various other elements of the buck-boost switching converter 500, in an example. The converter 500 of FIGS. 5A-5B is at least in part similar to the converter 100 of FIGS. 1A-1C, and similar components and signals in the two converters are labelled the same manner.

Referring to FIGS. 5A-5B, the converter 500 comprises a first voltage terminal T1 and a second voltage terminal T2. In an example, the terminal T1 can be an input terminal and terminal T2 can be an output terminal. In another example, the terminal T1 can be an output terminal and terminal T2 can be an input terminal. Similarly, in an example, the terminal T1 can have a relatively high voltage and terminal T2 can have a relatively low voltage. In another example, the terminal T1 can have a relatively low voltage and terminal T2 can have a relatively high voltage. In yet another example, the terminals T1 and T2 can be at a substantially same voltage level.

Thus, the converter 500 can operate in various different combinations of high and low voltages, and input and output terminals. In one example of a buck mode of operation of the converter 500, the terminal T1 can operate as an input terminal of the converter 500 and is provided with a high voltage V1, and the terminal T2 can operate as an output terminal and generate an output low voltage V2. In another example of the buck mode of operation of the converter 500, the terminal T2 can operate as an input terminal of the converter 500 and is provided with a high voltage V2, and the terminal T1 can operate as an output terminal and generate an output low voltage V1.

Similarly, in one example of a boost mode of operation of the converter 500, the terminal T1 can operate as an input terminal of the converter 500 and is provided with a low voltage V1, and the terminal T2 can operate as an output terminal and generate an output high voltage V2. In another example of the boost mode of operation of the converter 500, the terminal T2 can operate as an input terminal of the converter 500 and is provided with a low voltage V2, and the terminal T1 can operate as an output terminal and generate an output high voltage V1.

Thus, power flow in the converter 500 is bidirectional, and any of the terminals T1 and T2 can be an input or an output terminal, generating any of a high or a low voltage. In another example, when the voltage level of the terminals T1 and T2 are the same, no voltage conversion may be performed, and the converter 500 operates at a bypass mode of operation. To differentiate from the converter 100, the converter 500 is also referred to herein as a buck-boost converter. The converter 500, thus, can operate in any of a buck mode, a boost mode, or a bypass mode of operation.

In the example of FIGS. 5A-5B, the converter 500 is a dual channel converter, e.g., comprises two half-bridge power stages PS1 and PS2, similar to the converter 100. Each of the power stages PS1 and PS2 comprises a corresponding high side switch and a corresponding low side switch. For example, power stage PS1 comprises a high side switch S1 coupled between the terminal T1 and a switching terminal SW_A, and a low side switch S2 coupled between the switching terminal SW_A and a ground terminal. Similarly, power stage PS2 comprises a high side switch S2 coupled between the terminal T2 and another switching terminal SW_B, and a low side switch S4 coupled between the switching terminal SW_B and the ground terminal. In an example, the switches S1, . . . , S4 may be transistors, such as n-channel FETs, although other suitable switching elements may also be used.

A control terminal (such as a gate terminal) of the switch S1 is coupled to a control terminal HO1 of the chip 101 (see FIG. 5B), which provides a PWM1 control signal to the control terminal of the switch S1. A control terminal (such as a gate terminal) of the switch S2 is coupled to a control terminal LO1 of the chip 101, which provides a PWM2 control signal to the control terminal of the switch S2.

In an example, a high value or enable state of PWM1 and PWM2 signals respectively enable or turn on the switches S1 and S2, although a different control scheme may also be possible. Similarly, a low value or disable state of PWM1 and PWM2 signals respectively disable or turn off the switches S1 and S2.

A control terminal (such as a gate terminal) of the switch S3 is coupled to a control terminal HO2 of the chip 101, which provides a PWM3 control signal to the control terminal of the switch S3. A control terminal (such as a gate terminal) of the switch S4 is coupled to a control terminal LO2 of the chip 101, which provides a PWM4 control signal to the control terminal of the switch S4.

In an example, a high value or enable state of PWM3 and PWM4 signals respectively enable or turn on the switches S3 and S4, although a different control scheme may also be possible. Similarly, a low value or disable state of PWM3 and PWM4 signals respectively disable or turn off the switches S3 and S4.

When the switch S1 is enabled, the switch S1 provides the voltage V1 to the switching terminal SW_A. Similarly, when the switch S3 is enabled, the switch S3 provides the voltage V2 to the switching terminal SW_B. On the other hand, when the switch S2 is enabled, the switch S2 couples the ground terminal to the switching terminal SW_A. Similarly, when the switch S4 is enabled, the switch S4 couples the ground terminal to the switching terminal SW_B.

Similar to the converter 100, in the converter 500, the operation of the switches S1 and S2 are complementary in nature, and the operation of the switches S3 and S4 are complementary in nature.

The chip 501 comprises a terminal T3, as illustrated in FIGS. 5A-5B. For example, an inductor La is coupled between the switching terminal SW_A and the terminal T3, and a resistor R1 is coupled between the terminal T3 and the switching terminal SW_B. The terminal T3 may also be referred to herein as an inductor terminal.

In the converter 500, the terminal T1 is coupled to the ground through a resistive voltage divider comprising resistors Ra and Rb, similar to the converter 100. For example, the resistors Ra and Rb are coupled in series between the terminal T1 and the ground terminal. The resistor Rb also is coupled between the terminal T1 and a voltage sensing terminal V1_SNS on the chip 501, and the resistor Ra is coupled between the ground terminal and the voltage sensing terminal V1_SNS on the chip 501. The chip 501 senses the voltage at the voltage sensing terminal V1_SNS, to estimate a voltage V1 at the terminal T1. The terminal T1 is also coupled to the ground through a capacitor C1.

The terminal T2 is coupled to the ground through another resistive voltage divider comprising resistors Rc and Rd. For example, the resistors Rc and Rd are coupled in series between the terminal T1 and the ground terminal. The resistor Rc is coupled between the terminal T2 and a voltage sensing terminal V2_SNS on the chip 501, and the resistor Rd is coupled between the ground terminal and the voltage sensing terminal V2_SNS. The voltage sensing terminal V2_SNS is on the chip 501. The chip 501 senses the voltage at the voltage sensing terminal V2_SNS, to estimate a voltage V2 at the terminal T2. The terminal T2 is also coupled to the ground through a capacitor C2.

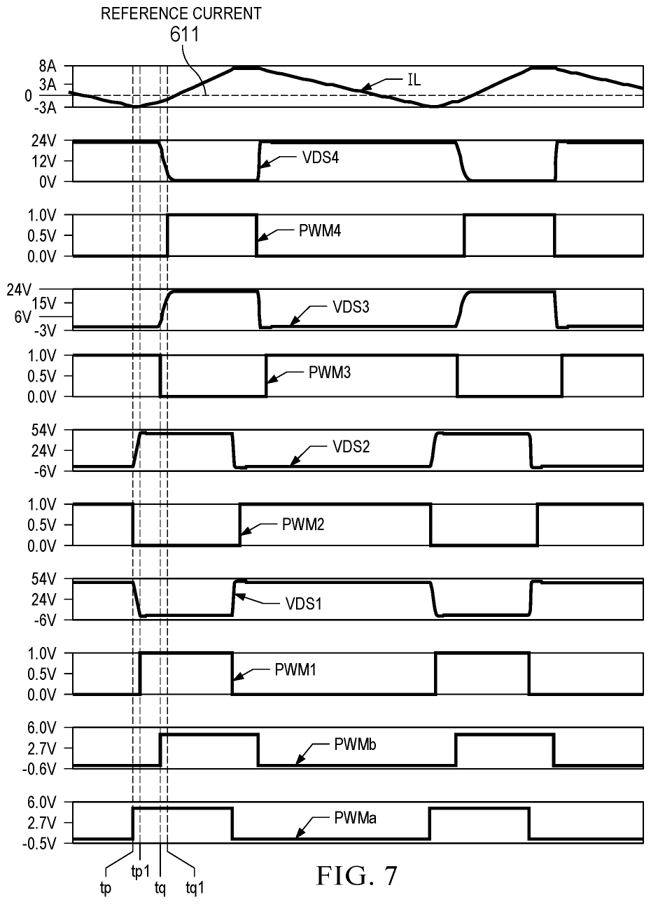

Although not illustrated, in an example, various parasitic capacitances CDS1, CDS2, CDS3, CDS4, CGD1, CGD2, CGD3, CGD4, CGS1, CGS2, CGS3, and CGS4 are formed at the switches S1, S2, S3, and S4, e.g., similar to the description with respect to FIG. 1B. In an example, the inductor La is selected to reverse charge across output capacitance Coss of the full-bridge in dead time, resulting negative minimum current with trapezoidal nature (the trapezoidal current waveform of the inductor current IL is illustrated in FIG. 7 below). In one embodiment, the inductor La have inductance in the range of 1-1000 nano Henry, or in a subrange thereof, such as about 300 to 600 nano Henry. In an example, the inductance of the inductor La is based on a frequency of operation of the converter 500. A higher frequency of the converter 500 necessitates a relatively lower value of the inductance, and vice versa.

As illustrated in FIG. 5A, a current through the inductor La, from switching terminal SW_B to switching terminal SW_A, is referred to as current IL. For example, the chip 501 has terminals T3 and SW_B for sensing voltages at these two terminals. In an example, the chip 501 measures the voltage across terminals T3 and SW_B, and knows the value of the resistor R1. Thus, by measuring the voltage drop across resistor R1, the chip 501 (e.g., the controller 504) estimates the current IL through the resistor R1 and also through the inductor L1.

A voltage across two current terminals of the switch S1 (e.g., across source and drain terminals of the switch S1) is referred to as VDS1. Similarly, voltages across two corresponding current terminals of the switches S2, S3, and S4 (e.g., across source and drain terminals of the corresponding switches) are respectively referred to as VDS2, VDS3, and VDS4, as labelled in FIG. 1A.

For example, the chip 501 (such as the controller 504) estimates the voltage V1 at terminal T1 (e.g., using the voltage divider comprising the resistors Ra and Rb, as described above). The chip 501 also senses the voltage at the switching terminal SW_A (e.g., the terminal SW_A is on the chip 501). Accordingly, the chip 501 estimates the voltage VDS1, by estimating the voltage difference between the terminals T1 and SW_A. The chip 501 similarly estimates the voltages VDS2, VDS3, and VDS4.

The controller 504 within the chip 501 controls switching operation of the converter 500. For example, the controller 504 provides the PWM1, . . . , PWM4 control signals to control switching of the switches S1, . . . , S4, thereby controlling switching operations of the converter 500.

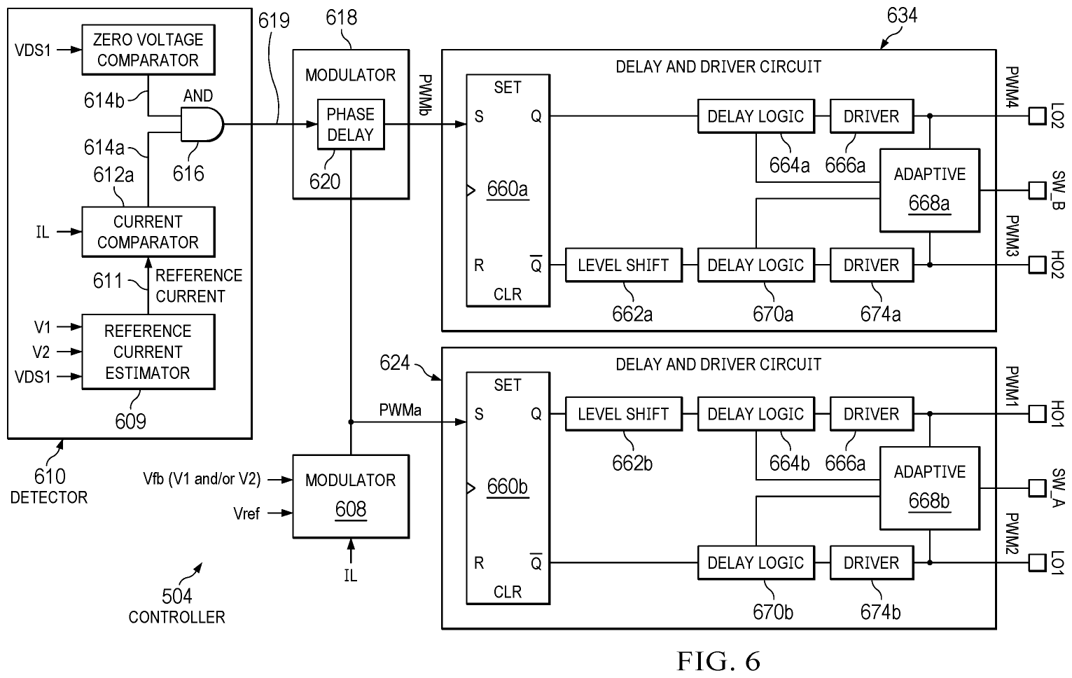

FIG. 6 illustrates the controller 504 of the converter 500 of FIGS. 5A-5B, in an example. FIG. 7 illustrates a timing diagram depicting an operation of the converter 500 of FIGS. 5A-6, in an example. FIGS. 6 and 7 are described in unison.

Referring to FIG. 6, the controller 504 comprises a modulator 608 that has a first input receiving a feedback voltage Vfb, and a second input receiving a reference voltage Vref. In one example, the feedback voltage Vfb is indicative of an output of the converter 500. In another example, the feedback voltage Vfb may be two separate voltages V1 and V2, in which case there may be two inputs receiving the feedback voltages Vfb (which are V1 and V2). Note that in an example, the modulator 608, instead of receiving the voltages V1 and/or V2, receives an output of the resistive voltage divider comprising the resistors Ra and Rb, and/or Rc and Rd as the feedback voltages Vfb (e.g., through sensing terminal V1_SNS and/or V2_SNS). The reference voltage Vref is a target output of the converter 500. In one embodiment, the modulator 608 also receives the current IL, and generates the pulse width modulated signal PWMa, based on the voltage(s) Vfb (which may be V1 and/or V2), the reference voltage Vref (which is a target output of the converter 500), and the current IL. In an example, the buck-boost bidirectional nature of power conversion is possible in the converter 500, e.g., as the converter 500 operates in a forced PWM mode with reference voltage used to compare an algebraic ratio of V1 and V2, e.g., to generate the error voltage for either direction (e.g., operating in a buck mode or a boost mode). In one embodiment, the buck-boost modulator 608 uses a control scheme to regulate various modes of operation (e.g., buck, boost, or buck-boost) for either terminals T1 or T2. In an example, both input voltages V1 and V2 are processed for a common feedback voltage, which is compared (e.g., using an error amplifier) with the reference voltage Vref, e.g., to determine target voltages for one or both terminals T1 and T2. The error voltage from the voltage loop is coupled to drive an average current loop with respect to average summation of inductor current IL over time. In an example, another appropriate modulation scheme may also be employed, such as a peak current modulation scheme, valley current modulation scheme, or hysteresis modulation scheme, for example.

The PWMa signal is used to generate control signals PWM1 and PWM2, which are respectively received by the control terminals of the switches S1 and S2. Thus, the PWMa signal effectively controls the two switches S1 and S2 of the power stage PS1.

For example, a delay and driver circuit 624 receives the PWMa signal, and generates the control signals PWM1 and PWM2. For example, the delay and driver circuit 624 generates the control signals PWM1 and PWM2, such that the control signals PWM1 and PWM2 are at least in part complimentary in nature, as also described above with respect to the converter 100.

Additionally, the delay and driver circuit 624 introduces a dead time delay between disabling of PWM2 and enabling of PWM1, such that there is a delay between switching off of the switch S2 and switching on of the switch S1 (see delay between time tp and time tp1 in FIG. 6 herein below). The dead time delay provides a safety margin, such that the switches S1 and S2 are not switched on simultaneously. In an example, the delay and driver circuit 624 has a structure and operation similar to the delay and driver circuit 324 of FIG. 2B described above, although other structure and/or function of the delay and driver circuit 624 may also be possible.

FIG. 7 illustrates the PWMa signal, and also illustrates the PWM1 and PWM2 signals derived from the PWMa signal by the delay and driver circuit 624. As illustrated in FIG. 7, PWM2 is substantially an inverter waveform of PWMa (e.g., when PWMa is high, PWM2 is low, and vice versa). The inversion may be achieved by a flip flop 660b of the delay and driver circuit 624 of FIG. 6.

In FIG. 7, the transition from low to high of the PWM1 signal is delayed with respect to that of the PWMa signal, such as delayed by the dead time delay described above, e.g., the delay between time tp when PWMa transitions from low to high and time tp1 when PWM1 transitions from low to high. The dead time delay provides a safety margin, such that the switches S1 and S2 are never switched on simultaneously.

Referring again to FIG. 6, the controller 504 further includes another modulator 618 that has a first input coupled to an output of the modulator 608, where the modulator 618 receives the PWMa signal from the modulator 508 via the first input. The modulator 618 also has a second input coupled to an output of a detector 610, where the modulator 618 receives an enable signal 619 from the detector 610 via the second input. In an example, based on the PWMa signal and the enable signal 619, the modulator 618 generates another PWMb signal, which is a pulse width modulated signal. In an example and as described below, the PWMb signal is a time-delayed or phase shifted version of the PWMa signal. Generation of the PWMb signal at the modulator 618 is described below.

In one embodiment, the PWMb signal is received by a delay and driver circuit 634, which generates PWM3 and PWM4 signals at terminals HO2 and LO2, respectively. The delay and driver circuit 634 may be at least in part similar to the delay and driver circuit 624 described above. For example, the delay and driver circuit 634 receives the PWMb signal, and generates the control signals PWM3 and PWM4, such that the control signals PWM3 and PWM4 are at least in part complimentary in nature. Additionally, the delay and driver circuit 634 introduces a dead time delay between disabling of PWM3 and enabling of PWM4, such that there is a delay between switching off of the switch S3 and switching on of the switch S4 (e.g., delay between times tq and tq1 in FIG. 7). The dead time delay provides a safety margin, such that the switches S3 and S4 are not switched on simultaneously.

Referring again to FIG. 6, the detector 610 asserts the enable signal 619, e.g., to delay the PWMb signal with respect to the PWMa signal. For example, referring to FIG. 7, the PWMa signal transitions to logic high state at time tp, based on which the PWM1 transitions to the logic high state at time tp1 (note the dead time delay between times tp and tp1, described above). However, the modulator 618 generates the PWMb signal, such that PWMb signal transitions to logic high state at time tq occurring subsequent to time tp. Thus, there is a delay of the PWMb signal with respect to PWMa signal. Once the PWMb transitions to high at time tq, PWM3 transitions to low at time tq and PWM4 transitions to high at time tq1 (note the dead time delay between times tq and tq1, described above).

Thus, the modulator 618 delays transition to high of the PWMb with respect to that of the PWMa signal. For example, the detector 610 monitors one or more parameters of the converter 500, and controls this delay through assertion of the enable signal 619. For example, referring to FIGS. 6 and 7, PWMb transitions to the high state at time tq, subsequent to PWMa transitioning to high state at time tp, when one or both of the following conditions are satisfied:

(A) current IL rises and crosses a reference current 611 (e.g., where the reference current 611 is estimated by a reference current estimator 609 of the detector 610, and the current IL is compared with the reference current 611 by a current comparator 612a of the detector 610), and/or Condition A

(B) voltage VDS1 is substantially zero (e.g., as monitored by a voltage comparator 612b of the detector 610). Condition B

For example, the detector 210 detects satisfaction of both the conditions A and B, and asserts an enable signal 619 when both of the conditions A and B are satisfied. In FIG. 7, the detector 610 detects a time tq when both the conditions A and B are satisfied, and asserts the enable signal at time tq. Based on the enable signal 619 being asserted at time tq, the modulator 618 transitions the PWMb signal at the high logic state at time tq, as illustrated in FIG. 7.

As illustrated in FIG. 7, due to the tuning of the inductor L, the current IL has a roughly trapezoidal shape. Also, when inductor current IL crosses the reference current 611 at tq, the voltage VDS1 is zero or close to zero, as illustrated in FIG. 7. For example, the reference current estimator 609 estimates the reference current 611, based on the voltages V1, V2, and VDS1. Note that when estimating the reference current 611, the voltages V1 and V2 has to be greater than zero. For example, when voltages V1 and V2 are zero, the voltage VDS1 is zero-however, the reference current estimator 609 excludes such a scenario for estimating the reference current 611. Accordingly, the reference current estimator 609 aims to estimate the reference current 611 only when V1 and V2 is greater than zero.

In an example, during a few cycles of operation of the converter 500, the reference current estimator 609 estimates the reference current 611. The controller 504 uses this value of the reference current 611 during the next few cycles of operation of the converter 500. The reference current estimator 609 may update this estimate of the reference current 611 periodically, on a continuous or at least a semi-continuous basis, and/or when there is a change in an operating condition of the converter 500 (e.g., change in load, input and/or output voltage levels, temperature, and/or another appropriate operating condition).

For example, referring to FIG. 7, the reference current estimator 609 estimates the reference current 611 to be a value of the current IL, when VDS1 stabilizes to a zero value, and when voltages V1 and/or V2 are greater than zero. For example, in FIG. 7, VDS1 goes to zero between time tp and tq. Note that although not illustrated in FIG. 7, there may be some ripples in the voltage VDS1 between time tp and time tq, which dies down substantially by time tq. Accordingly, the reference current 611 is the value of current IL at time tq. In the example of FIG. 7, the current IL is about −2 amperes (A) at this time. So, for the next few cycles of operation (e.g., until the reference current estimator 609 updates the estimate of the reference current 611), the detector 610 uses this value of the reference current 611 (which is −2 A, merely as an example). For example, the reference current estimator 609 provides this value of the reference current 611 to the current comparator 612a.

The current comparator 612a compares the reference current 611 with the inductor current IL, and asserts a signal 614a (e.g., transitions the signal 614 to a high or enable state) when the inductor current IL crosses the reference current 611. For example, for the timing diagram of FIG. 7, this happens at time tq, when the current IL has a rising edge exceeding the reference current 611 (which is about −2 A in the example of FIG. 7).

The detector 610 further comprises a voltage comparator 612b having an input to receive the voltage VDS1 across the current terminals of the switch S1. In an example, the voltage detector 612b is a zero voltage detector, such as detects when the voltage VDS1 has a substantially zero value. Thus, the voltage detector 612b compares the voltage VDS1 with a zero reference voltage. For example, referring to FIG. 7, the voltage VDS1 is zero at time tq. Thus, the voltage comparator 612b checks for the above described condition B. The voltage comparator 612b transitions a signal 614b to an enable state or otherwise asserts the signal 614b, in response to detecting the zero value of VDS1.

An AND logic gate 616 receives both the signals 614a and 614b, and outputs a signal 619, which is at an enable state when all inputs to the AND gate 616 are at the enable state (e.g., when the conditions A and B are satisfied).

Thus, the detector 610 detects the time tq when the conditions A and/or B are satisfied. Upon satisfaction of the conditions, the enable signal 619 has an enable stage (e.g., is asserted), based on which the modulator 618 transitions the PWMb signal to the enable or high state, as described above. For example, the modulator 618 comprises a phase delay logic 620, which delays the phase of the PWMa signal to generate the PWMb signal, where the delay is estimated based on when the enable signal 619 transitions to the enable state or is otherwise asserted. In an example, the delay between times tq and time tq1 may be based on an operating temperature of the converter 500, a load of the converter 500, a supply voltage (e.g., V1 or V2), and/or parasitic capacitances CDS1, . . . , CDS2. As described above, delaying the PWMb signal with respect to the PWMa signal results in reduced switching losses at one or more of the switches S1, . . . , S4 of the converter 500, thereby increasing an efficiency of the converter 500.

### Methodology

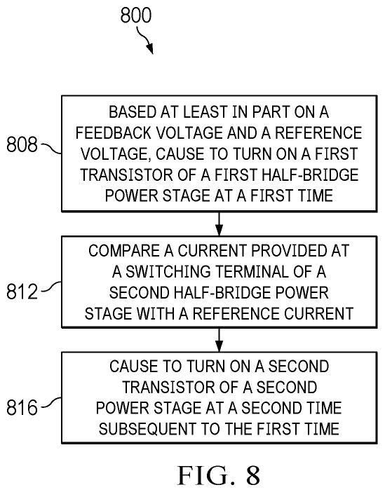

FIG. 8 is an example flowchart representative of a method 800 of operating a converter, such as any of the converters 100 or 50 described with respect to of FIGS. 1A-7, in an example.

At 808 of method 800, based at least in part on a feedback voltage Vfb and a reference voltage Vref, a first transistor of a first half-bridge power stage is caused to be turned on at a first time. For example, for the converter 100, the modulator 208 receives the voltages Vref, Vfb, and the currents IL1 and IL2, and generates the PWMa signal. Similarly, for the converter 500, the modulator 608 receives the voltages Vref, Vfb (which may be the voltages V1 and/or V2), and the current IL, and generates the PWMa signal. The PWMa signal transitions from a low to a high state (e.g., at time t1 of FIG. 4), and consequently, the PWM1 signal also transitions from a low to a high state (e.g., at time t1a of FIG. 4). Accordingly, this turns on the switch S1 of power stage PS1 in the converters 100 and 500.

The method 800 proceeds from 808 to 812. At 812, a current provided at a switching terminal of a second half-bridge power stage is compared with a reference current. For example, for the converter 100, the current comparator 212a compares the current IL2 at the switching terminal SW_B of the power stage PS2 with a zero reference current. For the converter 500, the current comparator 612a compares the current IL at any of the switching terminals SW_A and SW_B with a reference current 611.

The method 800 proceeds from 812 to 816. At 816, a second transistor of a second power stage is caused to be turned on at a second time subsequent to the first time. For example, for the converter 100, the above described comparison causes the modulator 218 to transition the PWMb signal (and consequently the PWM3 signal) from the low state to a high state, as a result of which the switch S3 is turned on at time t2a. For the converter 500, the above described comparison causes the modulator 618 to transition the PWMb signal (and consequently the PWM4 signal) from the low state to a high state, as a result of which the switch S4 is turned on at time tq2.

### Further Examples

Modifications are possible in the described embodiments and examples, and other embodiments and examples are possible, within the scope of the claims, such as the examples herein below.

Example 1. A controller comprising: a first modulator configured to generate a first control signal having an enable state at a first time, based at least in part on an output voltage of a power converter including a first half-bridge power stage and a second half-bridge power stage, wherein the enable state of the first control signal causes a first transistor of the first half-bridge power stage to be turned on; a detector configured to detect a second time occurring subsequent to the first time, based at least in part on a current provided at a switching terminal of the second half-bridge power stage; and a second modulator configured to generate a second control signal having an enable state at the second time, wherein the enable state of the second control signal causes a second transistor of the second half-bridge power stage to be turned on.

Example 2. The controller of example 1, wherein to detect the second time, the detector is configured to: compare the current provided at the switching terminal with a reference current; and detect the second time, based at least in part on comparing the current provided at the switching terminal with the reference current.

Example 3. The controller of example 2, wherein the reference current is zero current.

Example 4. The controller of any one of examples 2-3, wherein the reference current during a current switching cycle is based at least in part on a value of the current provided at the switching terminal during a third time occurring at a prior switching cycle, wherein during the third time, a voltage across a first current terminal and a second current terminal of the first transistor is zero.

Example 5. The controller of any one of examples 1-4, wherein to detect the second time, the detector is configured to: detect a zero-crossing of the current provided at the switching terminal; and detect the second time, based at least in part on detecting the zero-crossing of the current.

Example 6. The controller of any one of examples 1-5, wherein to detect the second time, the detector is configured to: compare a feedback voltage with a reference voltage; and detect the second time, based at least in part on comparing the feedback voltage with the reference voltage.

Example 7. The controller of example 6, wherein the feedback voltage is a voltage across a first current terminal and a second current terminal of the first transistor, and the reference voltage is at a ground potential.

Example 8. The controller of any one of examples 6-7, wherein the detector is configured to detect the second time, based at least in part on (i) a detection of a zero-crossing of the current provided at the switching terminal, and (ii) comparison of the feedback voltage with the reference voltage.

Example 9. A power system comprising the controller of any one of examples 6-8 and the power converter, wherein the power converter includes: an inductor coupled between the switching terminal and an inductor terminal of the power converter; wherein the first half-bridge power stage is coupled to a first voltage terminal, and the second half-bridge power stage is coupled to a second voltage terminal; wherein the feedback voltage is a voltage between the inductor terminal and any one of first or second voltage terminals; and wherein the reference voltage is equal to Y volts, where Y is within a range of V−T volts to V+T volts, V is equal to one-half of a voltage between the first or second voltage terminal and a ground terminal, and T is a tolerance equal to or less than V times 0.2.

Example 10. A power system comprising the controller of any one of examples 1-9 and the power converter, wherein the switching terminal is a first switching terminal, and wherein the power converter comprises: the first half-bridge power stage comprising (i) the first transistor coupled between a first voltage terminal and a second switching terminal, and (ii) a third transistor coupled between the second switching terminal and a ground terminal; and the second half-bridge power stage comprising (i) the second transistor coupled between a second voltage terminal and the first switching terminal, and (ii) a fourth transistor coupled between the first switching terminal and the ground terminal.

Example 11. The power system of example 10, wherein the power converter further comprises: a first inductor coupled between the first switching terminal and an inductor terminal; a second inductor coupled between the second switching terminal and the inductor terminal; and a third inductor coupled between the inductor terminal and a third voltage terminal of the power converter, wherein the first voltage terminal or the third voltage terminal provides the output voltage.

Example 12. The power system of example 11, wherein an inductance of each of the first and second inductors is at least two times less than an inductance of the third inductor.

Example 13. The power system of any one of examples 11-12, wherein an inductance of each of the first and second inductors is at least ten times less than an inductance of the third inductor.

Example 14. The power system of any one of examples 10-12, wherein the first and second voltage terminals are the same voltage terminal.

Example 15. The power system of any one of examples 10-14, wherein one of the first or second voltage terminals provides an input voltage to the power converter, and the other of the first or second voltage terminals provides the output voltage from the power converter.

Example 16. The power system of any one of examples 11-15, further comprising: an inductor coupled to the first switching terminal, wherein the current provided at the switching terminal passes through the inductor.

Example 17. The controller of any one of examples 1-16, wherein the controller is configured to cause the second transistor to be turned on after a delay from the second time.

Example 18. The controller of any one of examples 1-17, wherein to generate the second control signal, the second modulator is configured to delay the first control signal by a delay time equal to a difference between the second and first times, and wherein the second control signal is a delayed version of the first control signal.

Example 19. A controller comprising: a first modulator having (i) a first modulator input to receive a power converter output voltage, (ii) a second modulator input to receive a reference voltage, and (iii) a first modulator output to provide a first pulse width modulation (PWM) signal; a current comparator having (i) a current comparator input to receive a power converter switching terminal current, and (ii) a current comparator output; and a second modulator having (i) a third modulator input coupled to the current comparator output, (ii) a fourth modulator input coupled to the first modulator output, and (iii) a second modulator output to provide a second PWM signal.

Example 20. The controller of example 19, further comprising: a voltage comparator having (i) a voltage comparator input to receive a feedback voltage from the power converter, and (ii) a voltage comparator output that is coupled to the third modulator input of the second modulator.

Example 21. The controller of example 20, further comprising: a logical AND gate having (i) a first AND input coupled to the current comparator output, (ii) a second AND input coupled to the voltage comparator output, and (iii) an AND output coupled to the third modulator input.

Example 22. The controller of any one of examples 20-21, wherein: the feedback voltage is a voltage across a switching transistor of a half-bridge power stage of the power converter; and the voltage comparator is configured to compare the feedback voltage to a ground potential.

Example 23. The controller of any one of examples 20-22, wherein: the voltage comparator input is a first voltage comparator input; the feedback voltage is a voltage between a voltage terminal and an inductor terminal; and the voltage comparator further has a second voltage comparator input to receive a reference voltage from the converter system, wherein reference voltage is a voltage between the voltage terminal and a ground terminal.

Example 24. The controller of any one of examples 19-23, wherein the current comparator is a zero current crossing detector.

Example 25. The controller of any one of examples 19-24, further comprising: a first delay and driver circuit having (i) a first driver input coupled to the first modulator output, (ii) a first driver output to provide a third PWM signal, and (iii) a second driver output to provide a fourth PWM signal; and a second delay and driver circuit having (i) a second driver input coupled to the second modulator output, (ii) a third driver output to provide a fifth PWM signal, and (iii) a fourth driver output to provide a sixth PWM signal.

Example 26. A power system comprising the controller of example 25 and the power converter, wherein the converter system includes: a first half-bridge power stage comprising (i) a first transistor having a control terminal coupled to the first driver output, and (ii) a second transistor having a control terminal coupled to the second driver output; and a second half-bridge power stage comprising (i) a third transistor having a control terminal coupled to the third driver output, and (ii) a fourth transistor having a control terminal coupled to the fourth driver output.

Example 27. A method comprising: based at least in part on a feedback voltage of a direct current (DC)-DC converter and a reference voltage, causing to turn on a first transistor of a first half-bridge power stage of the DC-DC converter; comparing a current provided at a switching terminal of a second half-bridge power stage of the DC-DC converter with a reference current; and causing to turn on a second transistor of the second half-bridge power stage, based at least in part on comparing the current.

Example 28. The method of example 27, wherein the feedback voltage is a first feedback voltage, the reference voltage is a first reference voltage, and the method further comprising: comparing a second feedback voltage with a second reference voltage; wherein causing to turn on the second transistor is further based at least in part on comparing the second feedback voltage with the second reference voltage.

Example 29. The method of example 28, wherein the second feedback voltage is a voltage across a first current terminal and a second current terminal of the first transistor, and the second reference voltage is zero volt.

Example 30. The method of example 29, wherein an inductor is coupled between the second switching terminal and an inductor terminal of the DC-DC converter system, and wherein the second feedback voltage is a voltage between a voltage terminal of the DC-DC converter system and the inductor terminal, and the reference voltage is substantially half of a voltage between the voltage terminal and a ground terminal.

Example 31. The method of any one of examples 27-30, wherein the first feedback voltage is an output voltage of the DC-DC converter system, and the first reference voltage is target output voltage.

Example 32. The method of any one of examples 27-31, wherein the reference current is a zero current.

Example 33. The method of any one of examples 27-32, further comprising: determining a value the reference current.

Example 34. The method of example 33, wherein determining the value of the reference current comprises: determining a value of the current provided at the second switching terminal, when a voltage across a first current terminal and a second current terminal of the first transistor is zero; and using the determined value of the current as the value of the reference current.

Example 35. The method of any one of examples 27-34, wherein causing to turn on the first transistor of the first half-bridge power stage of the DC-DC converter further comprises: averaging a summation of a first inductor current and a second inductor current of the DC-DC converter; and based at least in part on the averaging, causing to turn on the first transistor of the first half-bridge power stage of the DC-DC converter.

Example 36. A converter system comprising: a first transistor coupled between a first voltage terminal and a first switching terminal; a second transistor coupled between the first switching terminal and a ground terminal; a third transistor coupled between a second voltage terminal and a second switching terminal; a fourth transistor coupled between the second switching terminal and the ground terminal; and a controller configured to (i) cause the first transistor to be turned on at a first time, based at least in part on an output voltage of the converter system, (ii) detect a second time occurring subsequent to the first time, based at least in part on a current provided at the second switching terminal, and (iii) cause the third transistor to be enabled at or subsequent to the second time.

Example 37. The converter system of example 36, wherein the controller is configured to detect the second time, based at least in part on a detection of a zero-crossing of the current provided at the second switching terminal.

Example 38. The converter system of any one of examples 36-37, wherein the controller is configured to detect the second time, based further at least in part on a comparison of a feedback voltage with a reference voltage.

Example 39. The converter system of example 38, wherein the feedback voltage is a voltage across a first current terminal and a second current terminal of the first transistor, and the reference voltage is at a ground potential.

Example 40. The converter system of any one of examples 38-39, further comprising: an inductor coupled between the first switching terminal and an inductor terminal of the converter system; wherein the feedback voltage is a voltage between the inductor terminal and any one of first or voltage terminals, and the reference voltage is equal to Y volts, wherein Y is within the range of V−T volts to V+T volts, and wherein V is equal to one-half of a voltage between the ground terminal and any one of first or voltage terminals, and T is tolerance equal to or less than V times 0.2.

Example 41. The converter system of any one of examples 38-40, wherein the controller is configured to detect the second time, based at least in part on (i) a detection of a zero-crossing of the current provided at the second switching terminal, and (ii) comparison of the feedback voltage with the reference voltage.

Example 42. The converter system of any one of examples 36-41, further comprising: a first inductor coupled between the first switching terminal and an inductor terminal; a second inductor coupled between the second switching terminal and the inductor terminal; and a third inductor coupled between the inductor terminal and a third voltage terminal of the converter system, wherein the first voltage terminal or the third voltage terminal provides the output voltage.

Example 43. The converter system of example 42, wherein an inductance of each of the first and second inductors is at least two times less than an inductance of the third inductor.

Example 43a. The converter system of any one of examples 42-43, wherein an inductance of each of the first and second inductors is at least ten times less than an inductance of the third inductor.

Example 44. The converter system of any one of examples 33-43a, further comprising: an inductor coupled to the second switching terminal, wherein the current provided at the second switching terminal passes through the inductor.

Example 45. The converter system of any one of examples 33-44, wherein the controller is configured to cause the third transistor to be turned on after a delay from the second time.

Example 46. The converter system of any one of examples 33-45, wherein the first and second voltage terminals are a same voltage terminal.

Example 47. The converter system of any one of examples 33-46, wherein one of the first or second voltage terminals provide an input voltage to the converter system, and the other of the first or second voltage terminals provide the output voltage from the converter system.

Example 48. A system comprising: a first transistor coupled between a first voltage terminal and a first switching terminal; a second transistor coupled between the first switching terminal and a ground terminal; a third transistor coupled between the first voltage terminal and a second switching terminal; a fourth transistor coupled between the second switching terminal and the ground terminal; an inductor terminal; a first inductor coupled between the first switching terminal and the inductor terminal; a second inductor coupled between the second switching terminal and the inductor terminal; and a third inductor coupled between the inductor terminal and a second voltage terminal voltage terminal.

Example 49. The system of example 48, wherein an inductance of the third inductor is at least 10 times larger than inductances of each of the first and second inductors.

Example 50. The system of any one of examples 48-49, wherein the first and second inductors are implemented as conductive traces, and the first inductor is implemented as a discrete inductor.

Example 51. The system of any one of examples 48-50, further comprising: a controller configured to output a first pulse width modulation (PWM) signal to control the first transistor, and a second PWM signal to control the third transistor, wherein the second PWM signal is delayed with respect to the first PWM signal.

Example 52. The system of example 51, wherein: the controller is configured to delay the second PWM signal with respect to the first PWM signal, based at least in part on (i) a voltage drop across first and second current terminals of the first transistor and (ii) a current through the second inductor.

Example 53. The system of any one of examples 48-52, further comprising: a controller configured to (i) generate a first control signal having an enable state at a first time, to cause to turn on the first transistor, and (ii) generate a second control signal having an enable state at a second time, to turn on the third transistor, the second time occurring subsequent to the first time.

Example 54. The system of example 53, wherein the controller is configured to generate the second control signal having the enable state at the second time, responsive to detecting substantially zero values of (i) a voltage drop across first and second current terminals of the first transistor and (ii) a current through the second inductor.

Example 55. The system of example 54, wherein the zero value voltage drop across the first and second current terminals of the first transistor is within the range of −100 millivolts to +100 millivolts, and the zero value current through the second inductor is within the range of −100 milliamps to +100 milliamps.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device, or a semiconductor component. Furthermore, a voltage rail or more simply a “rail,” may also be referred to as a voltage terminal and may generally mean a common node or set of coupled nodes in a circuit at the same potential.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end user and/or a third party.

While the use of particular transistors is described herein, other transistors (or equivalent devices) may be used instead. For example, a p-channel field effect transistor (PFET) may be used in place of an n-channel field effect transistor (NFET) with little or no changes to the circuit. Furthermore, other types of transistors may be used (such as bipolar junction transistors (BJTs)). Furthermore, the devices may be implemented in/over a silicon substrate (Si), a silicon carbide substrate (SiC), a gallium nitride substrate (GaN) or a gallium arsenide substrate (GaAs). Moreover, reference to transistor features such as gate, source, or drain is not intended to exclude any suitable transistor technologies. For instance, features such as source, drain, and gate are typically used to refer to a FET, while emitter, collector, and base are typically used to refer to a BJT. Such features may be used interchangeably herein. For instance, reference to the gate of a transistor may refer to either the gate of a FET or the base of a BJT, and vice-versa. In some examples, a control terminal may refer to either the gate of a FET or the base of a BJT. Any other suitable transistor technologies can be used. Any such transistors can be used as a switch, with the gate or base or other comparable feature acting as a switch select input that can be driven to connect the source and drain (or the emitter and collector, as the case may be).

References herein to a field effect transistor (FET) being “ON” (or a switch being closed) means that the conduction channel of the FET is present, and drain current may flow through the FET. References herein to a FET being “OFF” (or a switch being open) means that the conduction channel is not present, and drain current does not flow through the FET. A FET that is OFF, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately,” “roughly,” or “substantially” preceding a parameter means being within +/−10 percent of that parameter.

Modifications are possible in the described examples, and other examples are possible within the scope of the claims.

What is claimed is:

1. A controller comprising:
a first modulator configured to generate a first control signal having an enable state at a first time, based at least in part on an output voltage of a power converter including a first half-bridge power stage and a second half-bridge power stage, wherein the enable state of the first control signal causes a first transistor of the first half-bridge power stage to be turned on;
a detector configured to detect a second time occurring subsequent to the first time, based at least in part on a current provided at a switching terminal of the second half-bridge power stage; and
a second modulator configured to generate a second control signal having an enable state at the second time, wherein the enable state of the second control signal causes a second transistor of the second half-bridge power stage to be turned on.

2. The controller of claim 1, wherein to detect the second time, the detector is configured to:
compare the current provided at the switching terminal with a reference current; and
detect the second time, based at least in part on comparing the current provided at the switching terminal with the reference current.

3. The controller of claim 2, wherein the reference current is zero current.

4. The controller of claim 2, wherein the reference current during a current switching cycle is based at least in part on a value of the current provided at the switching terminal during a third time occurring at a prior switching cycle, wherein during the third time, a voltage across a first current terminal and a second current terminal of the first transistor is zero.

5. The controller of claim 1, wherein to detect the second time, the detector is configured to:
detect a zero-crossing of the current provided at the switching terminal; and
detect the second time, based at least in part on detecting the zero-crossing of the current.

6. The controller of claim 1, wherein to detect the second time, the detector is configured to:
compare a feedback voltage with a reference voltage; and
detect the second time, based at least in part on comparing the feedback voltage with the reference voltage.

7. The controller of claim 6, wherein the feedback voltage is a voltage across a first current terminal and a second current terminal of the first transistor, and the reference voltage is at a ground potential.

8. The controller of claim 6, wherein the detector is configured to detect the second time, based at least in part on (i) a detection of a zero-crossing of the current provided at the switching terminal, and (ii) comparison of the feedback voltage with the reference voltage.

9. A power system comprising the controller of claim 6 and the power converter, wherein the power converter includes:
an inductor coupled between the switching terminal and an inductor terminal of the power converter;
wherein the first half-bridge power stage is coupled to a first voltage terminal, and the second half-bridge power stage is coupled to a second voltage terminal;
wherein the feedback voltage is a voltage between the inductor terminal and any one of first or second voltage terminals; and
wherein the reference voltage is equal to Y volts, where Y is within a range of V−T volts to V+T volts, V is equal to one-half of a voltage between the first or second voltage terminal and a ground terminal, and T is a tolerance equal to or less than V times 0.2.

10. A power system comprising the controller of claim 1 and the power converter, wherein the switching terminal is a first switching terminal, and wherein the power converter comprises:
the first half-bridge power stage comprising (i) the first transistor coupled between a first voltage terminal and a second switching terminal, and (ii) a third transistor coupled between the second switching terminal and a ground terminal; and
the second half-bridge power stage comprising (i) the second transistor coupled between a second voltage terminal and the first switching terminal, and (ii) a fourth transistor coupled between the first switching terminal and the ground terminal.

11. The power system of claim 10, wherein the power converter further comprises:
a first inductor coupled between the first switching terminal and an inductor terminal;
a second inductor coupled between the second switching terminal and the inductor terminal; and
a third inductor coupled between the inductor terminal and a third voltage terminal of the power converter, wherein the first voltage terminal or the third voltage terminal provides the output voltage.

12. The power system of claim 11, wherein an inductance of each of the first and second inductors is at least two times less than an inductance of the third inductor.

13. The power system of claim 10, wherein the first and second voltage terminals are the same voltage terminal.

14. The power system of claim 10, wherein one of the first or second voltage terminals provides an input voltage to the power converter, and the other of the first or second voltage terminals provides the output voltage from the power converter.

15. The controller of claim 1, wherein the controller is configured to cause the second transistor to be turned on after a delay from the second time.

16. The controller of claim 1, wherein to generate the second control signal, the second modulator is configured to delay the first control signal by a delay time equal to a difference between the second and first times, and wherein the second control signal is a delayed version of the first control signal.

17. A controller comprising:
a first modulator having (i) a first modulator input to receive a power converter output voltage, (ii) a second modulator input to receive a reference voltage, and (iii) a first modulator output to provide a first pulse width modulation (PWM) signal;
a current comparator having (i) a current comparator input to receive a power converter switching terminal current, and (ii) a current comparator output; and
a second modulator having (i) a third modulator input coupled to the current comparator output, (ii) a fourth modulator input coupled to the first modulator output, and (iii) a second modulator output to provide a second PWM signal.

18. The controller of claim 17, further comprising:
a voltage comparator having (i) a voltage comparator input to receive a feedback voltage from the power converter, and (ii) a voltage comparator output that is coupled to the third modulator input of the second modulator.

19. The controller of claim 18, further comprising:
a logical AND gate having (i) a first AND input coupled to the current comparator output, (ii) a second AND input coupled to the voltage comparator output, and (iii) an AND output coupled to the third modulator input.

20. The controller of claim 17, further comprising:
a first delay and driver circuit having (i) a first driver input coupled to the first modulator output, (ii) a first driver output to provide a third PWM signal, and (iii) a second driver output to provide a fourth PWM signal; and
a second delay and driver circuit having (i) a second driver input coupled to the second modulator output, (ii) a third driver output to provide a fifth PWM signal, and (iii) a fourth driver output to provide a sixth PWM signal.

21. A method comprising:
based at least in part on a feedback voltage of a direct current (DC)-DC converter and a reference voltage, causing to turn on a first transistor of a first half-bridge power stage of the DC-DC converter;
comparing a current provided at a switching terminal of a second half-bridge power stage of the DC-DC converter with a reference current; and
causing to turn on a second transistor of the second half-bridge power stage, based at least in part on comparing the current.

22. The method of claim 21, wherein the feedback voltage is a first feedback voltage, the reference voltage is a first reference voltage, and the method further comprising:
comparing a second feedback voltage with a second reference voltage;
wherein causing to turn on the second transistor is further based at least in part on comparing the second feedback voltage with the second reference voltage.

23. The method of claim 21, wherein the reference current is a zero current.

24. The method of claim 21, wherein the switching terminal is a first switching terminal, and wherein the method further comprises:
determining a value of the current provided at a second switching terminal, when a voltage across a first current terminal and a second current terminal of the first transistor is zero; and
using the determined value of the current as the value of the reference current.

25. The method of claim 21, wherein causing to turn on the first transistor of the first half-bridge power stage of the DC-DC converter further comprises:
averaging a summation of a first inductor current and a second inductor current of the DC-DC converter; and
based at least in part on the averaging, causing to turn on the first transistor of the first half-bridge power stage of the DC-DC converter.
